(19) United States
(12) Patent Application Publication
(10) Pub. No.: US 2018/0369974 A1
(43) Pub. Date: Dec. 27, 2018

(54) MACHINE TOOL

(71) Applicant: RÖHM GMBH, Sontheim (DE)

(72) Inventor: Stefan KEMPTER, Landensberg (DE)

(73) Assignee: RÖHM GMBH, Sontheim (DE)

(21) Appl. No.: 16/060,929

(22) PCT Filed: Nov. 21, 2016
(86) PCT No.: PCT/EP2016/078270

§ 371 Date: Jun. 9, 2018

(30) Foreign Application Priority Data
Dec. 9, 2015 (DE) 10 2015 121 393.1

(51) Int. Cl. B23Q 1/70; B23Q 1/00; B23Q 3/12; B23B 31/177

(52) U.S. Cl. CPC B23Q 1/70; B23Q 1/0009; B23B 2231/10; B23B 31/16233; B23Q 3/12

(57) ABSTRACT

The invention relates to a machine tool apparatus having a spindle (2), with a base flange (4) provided for attachment to the spindle (2) as part of a clamping tool quick-change tooling system (1), which further comprises an exchangeable flange (5), which is connectable to the chucking tool (3). Line sections (46) for data and/or energy transfer are arranged in the spindle (2), the base flange (4), the exchangeable flange (5) and the chucking tool (6), whereby coupling members (47) for connecting the line sections (46) to form a single line (FIG. 11) are provided on adjacent components in the transfer chain.

The invention relates to a machine tool with a spindle with a base flange provided for attachment to the spindle as part of a quick-change tooling system, which further comprises an exchangeable flange connectable to the chucking tool.

Such machine tools, in which the body of a chuck is attached via bolt connections in a conventional manner on the free end of the spindle, are known in practice. This type of attachment requires high set-up times, when the user wants to change the chuck, which is why quick-change tooling systems, in which the base flange is connected to the spindle, are currently used in commercial applications. This base flange is configured such that a releasable connection may be made to one of a plurality of flanges, whereby each of the exchangeable flanges supports a different chucking tool. Such a quick-change tooling system, as described, e.g., in DE 10 2013 216 179 A1, allows for reducing the set-up times and thus relatively frequently replacing the chucking tool with another. Following an exchange, however, the chucking tool currently in use needs to be adjusted via the machine control system, e.g., in order to avoid exceeding the maximum actuating force or the maximum rotational speed.

The object of the invention is therefore to increase the reliability of a machine tool of the type mentioned in the introduction.

This object is achieved in a machine tool of the type mentioned above in that line sections for data and/or energy transfer are arranged in the spindle, the base flange, the exchangeable flange and the chucking tool, and in that coupling members for connecting the line sections to form a single line are provided in the components adjacent to the transfer chain.

The advantage associated with a machine tool configured in this way is that data provided in or detected by the chucking tool may be transferred to the machine tool via the line sections, which are combined to form a single line, and from there, in particular, to the machine control, such that when the chucking tool is replaced in a “plug and play” manner, automated detection of the chucking tool and corresponding adaptation can occur.

It should also be noted that the line sections combined to a single line are also suitable for energy transfer, thus optionally allowing for loads arranged in the chucking tool, e.g., sensors, to be supplied with electrical energy. Thus, a log may be maintained directly in the chucking tool, in which characteristic operating data, such as operating hours, maximum rotational speeds, average rotational speeds and ambient temperature are recorded and passed to the machine tool after an exchange of the chucking tool.

In the context of the invention, the base flange preferably has at least two jaws, which are radially adjustable relative to the spindle axis, with a radially formed groove, as well as a drive ring provided for adjusting the jaws, when the exchangeable flange has a neck with a radially projecting collar, and when the contacting walls of the groove of the collar for creating a pull-down effect are designed in an inclined fashion. This structural design ensures high repeat accuracy via the pull-down effect and with a clearly defined axial alignment between the base flange and the exchangeable flange, such that this precise position relative to one another may be utilized for configuring and selecting the coupling members. It is therefore, in particular, possible that at least two adjacent coupling members are designed as a plug-socket connection. Alternatively, at least two adjacent coupling members may be designed optionally as inductive couplers, whereby in particular the high repeat accuracy relative to the axial arrangement ensures that the maximum and minimum distance is complied with for the inductive coupler.

Moreover, in the context of the invention, one of at least two adjacent coupling members may optionally be configured by a plurality of contact points and the other, by corresponding resilient pins.

A further alternative in the context of the invention is characterized in that at least one of two adjacent coupling members is configured by a circuit board with at least one contact loop, and the other, by at least one resilient pin.

It should be noted here that more than one pair of coupling members may be used between adjacent components, whereby identical pairs of coupling members need not always be used. It is therefore conceivable that inductive couplers, as well as plug-socket connections, can be used between two adjacent components. It is also possible to switch between the type of coupling-member pairs along the line formed from line sections, such that different coupling-member pairs may be present on either or both sides of a component.

For a simple design, it is advantageous that the contact points of all adjacent components in the transfer chain be arranged linearly and coaxially relative to the spindle axis, whereby alternatively offsetting the line sections between adjacent components is certainly also conceivable, i.e., a transverse line in a component extends in an inclined or perpendicular fashion relative to the component axis from one contact point to the other.

In order to increase operational reliability, it is further provided that the contact points be sealed by gaskets or O-rings relative to the environment.

The invention further relates to an exchangeable flange for a quick-change tooling system, in which a line section extending continuously from top to bottom is provided for data and/or energy transfer, and which has terminal coupling members for contacting coupling members of the line sections in the base flange and the chucking tool.

The invention will be explained in more detail below with reference to the embodiments shown in the drawing:

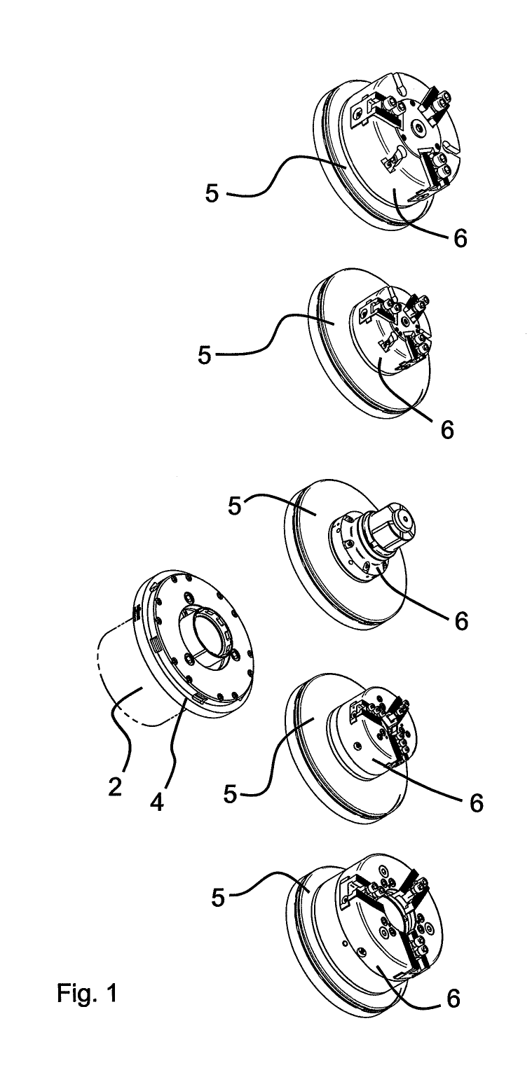

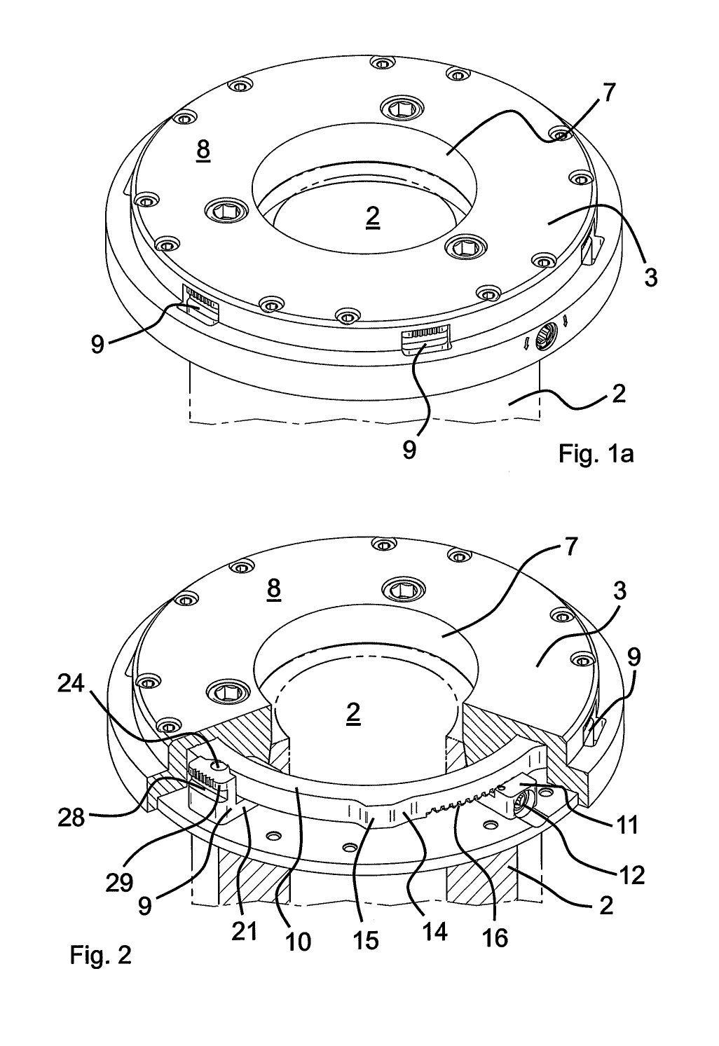

FIG. 1 A perspective view of the quick-change tooling system with a plurality of alternative workpiece chucking tools arranged on exchangeable flanges.

FIG. 1a A perspective view of the chucking tool as a base flange with the jaws in the open position;

FIG. 2 A view corresponding to FIG. 1a with a sectoral cutout of the chucking tool body,

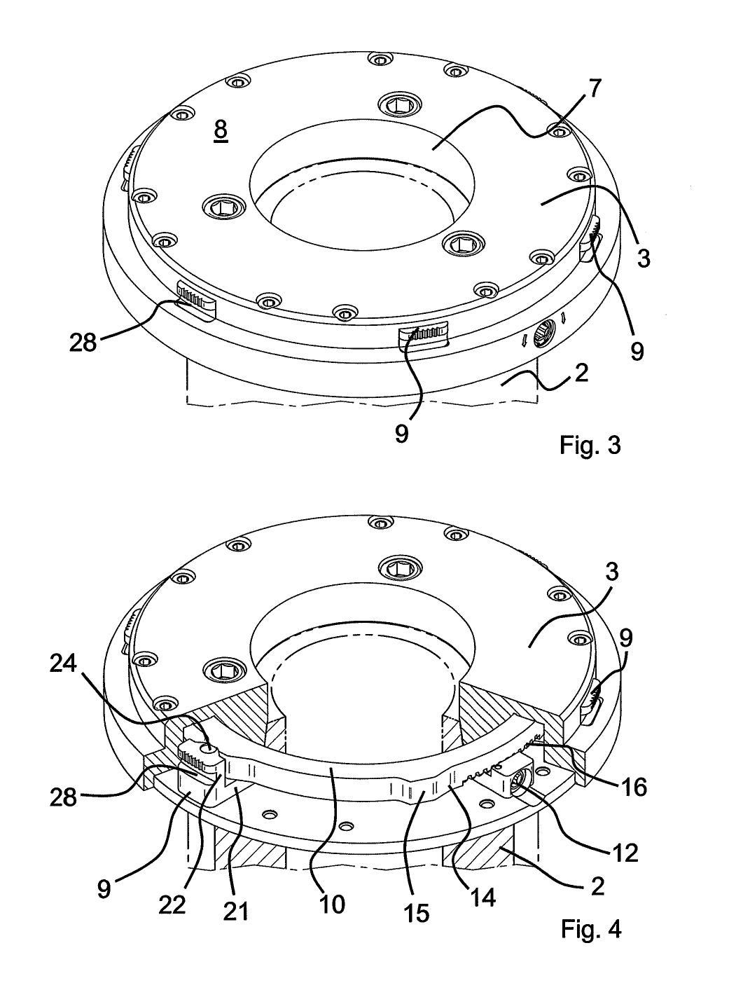

FIG. 3 A view corresponding to FIG. 1a with the jaws in the clamping position;

FIG. 4 A view corresponding to FIG. 2 of the chucking tool in FIG. 3;

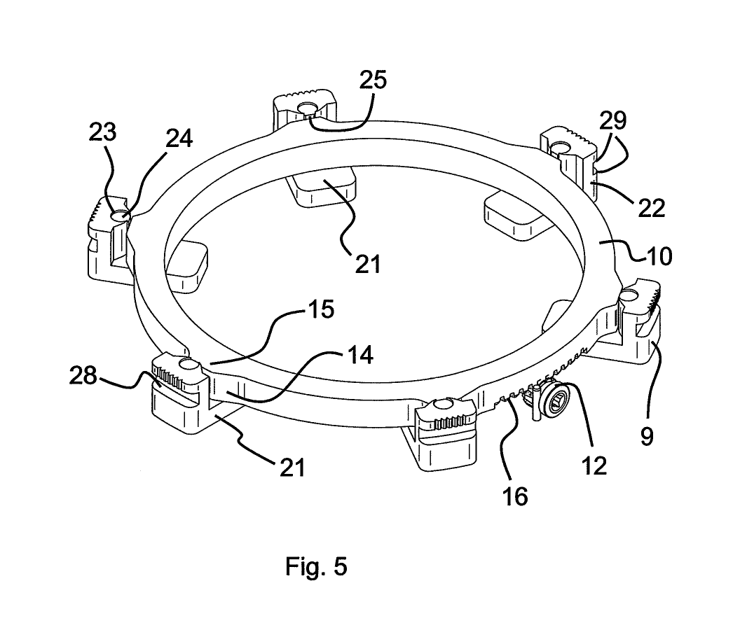

FIG. 5 An isolated, perspective view of the drive ring with the jaws in the clamping position;

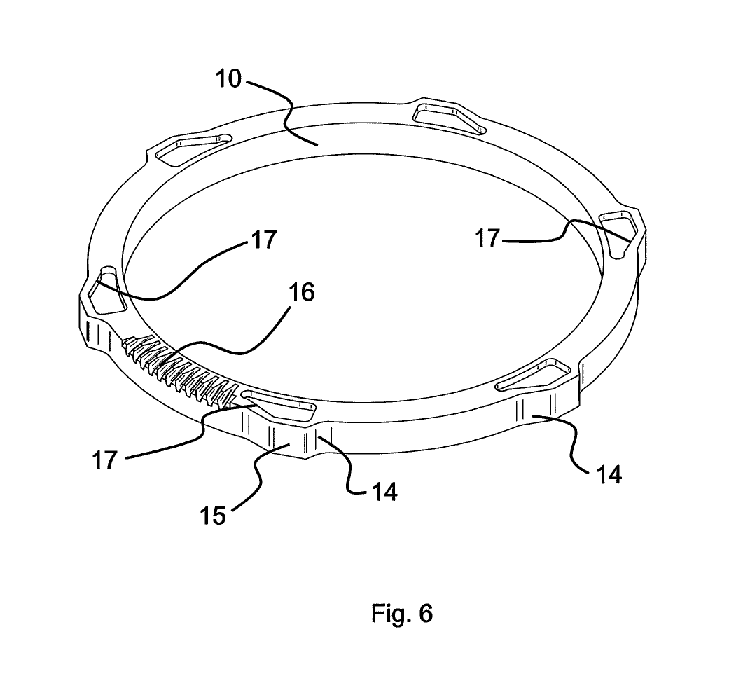

FIG. 6 A perspective view of the drive ring seen from below;

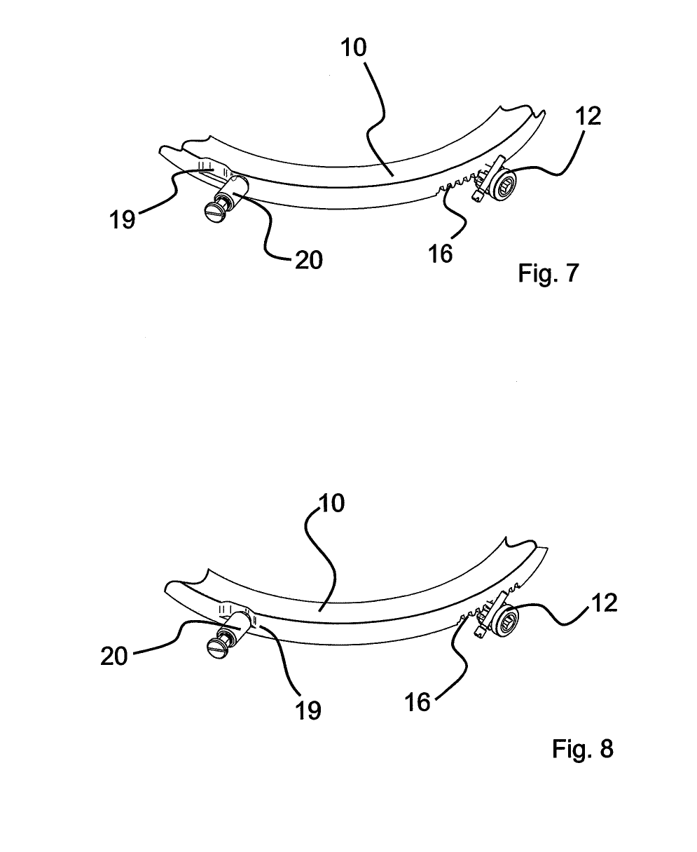

FIG. 7 A perspective view of the drive ring with the indicator curve and indicator pin in one rotational position;

FIG. 8 A view corresponding to FIG. 7 in the other rotational position;

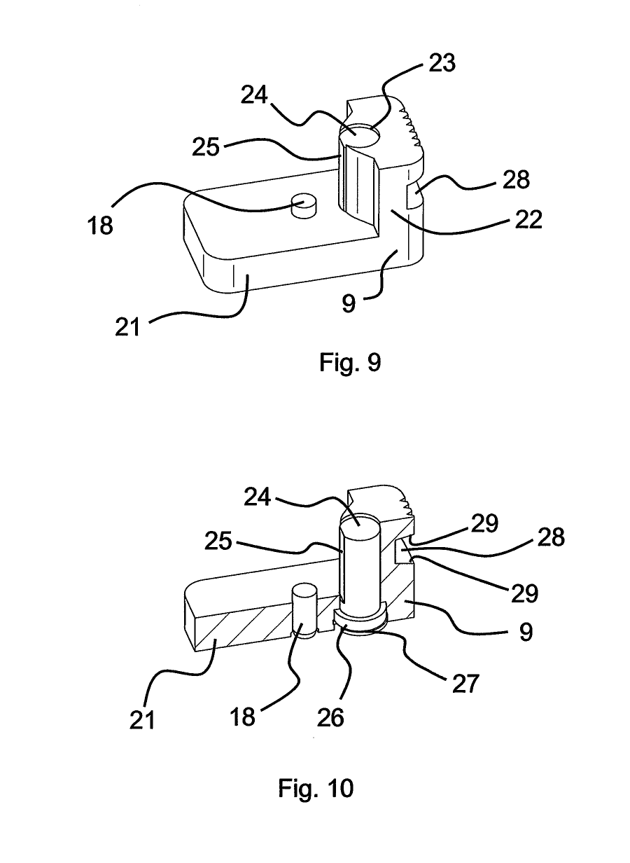

FIG. 9 A perspective view of the isolated jaws;

FIG. 10 A cross-section through the jaws;

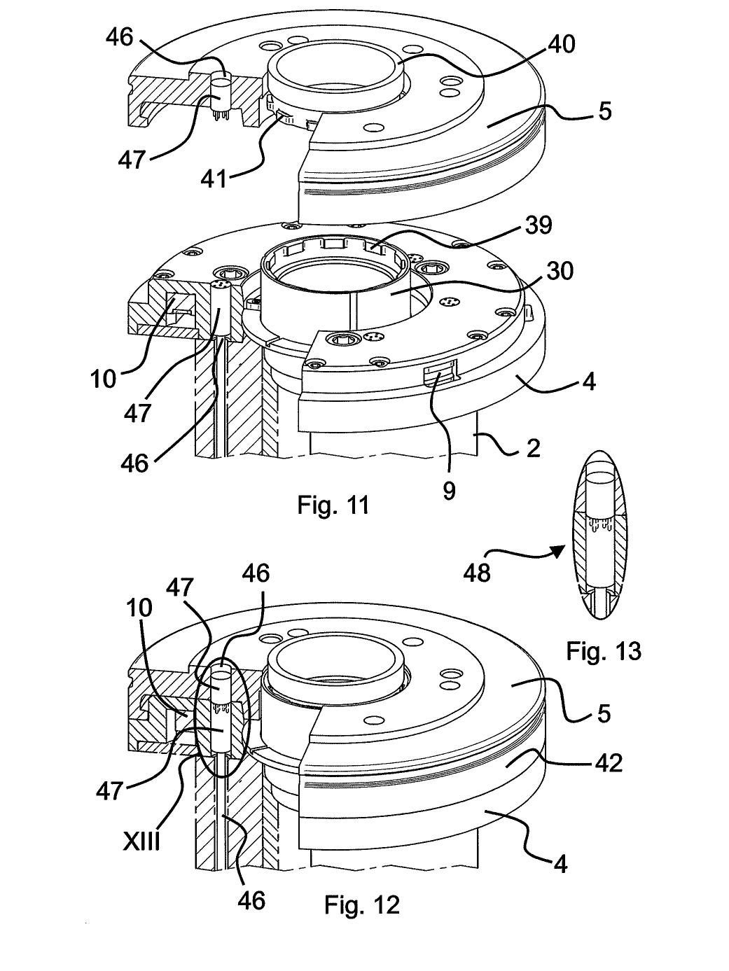

FIG. 11 A perspective view of the quick-change tooling system with an exchangeable flange separated from the base flange with a sectoral cutout showing the drawing sections and coupling members;

FIG. 12 A view corresponding to FIG. 11 of the assembled state;

FIG. 13 The detail XIII from FIG. 12;

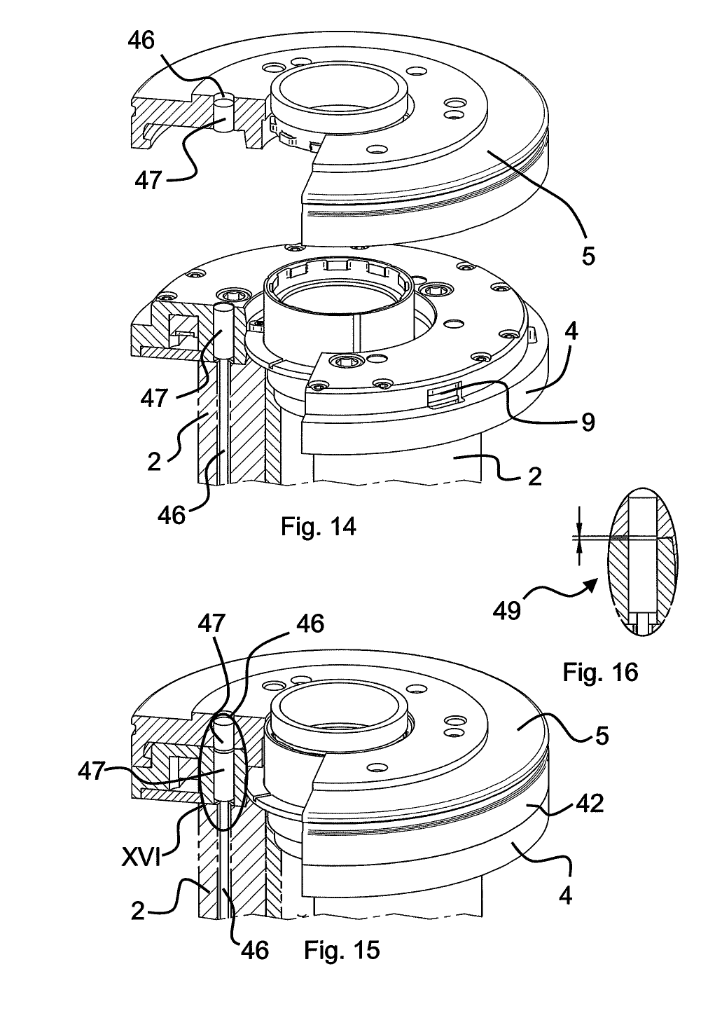

FIG. 14 A view corresponding to FIG. 11 with inductive couplers as alternative coupling members;

FIG. 15 A view corresponding to FIG. 12 with the alternative coupling members;

FIG. 16 The detail XVI from FIG. 15;

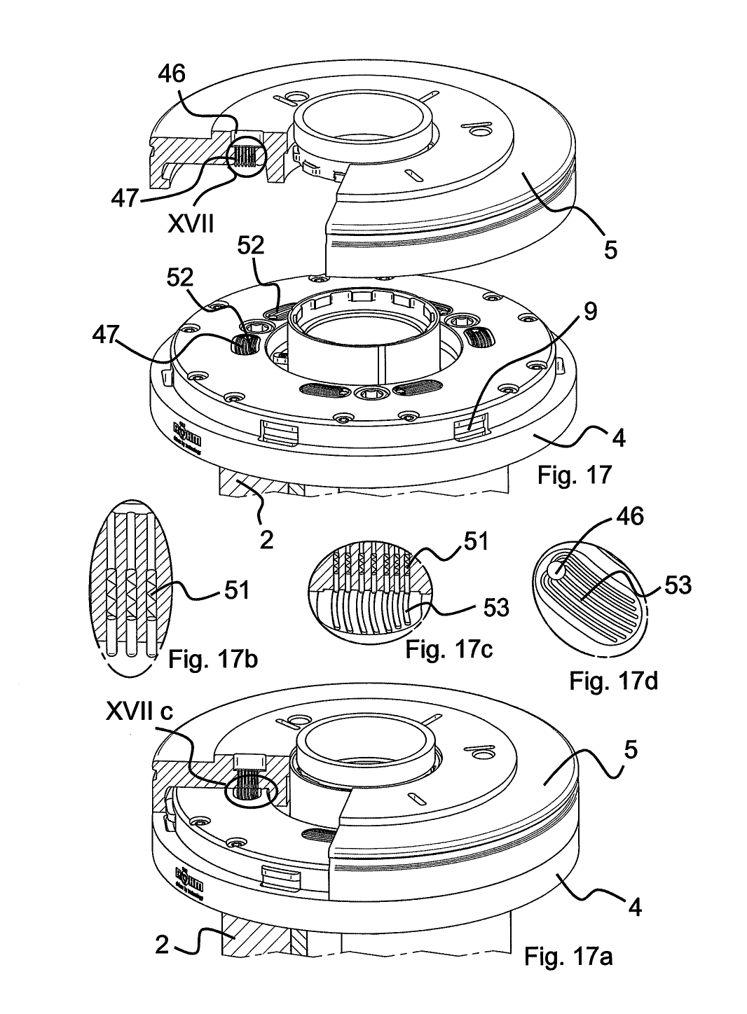

FIG. 17 A view corresponding to FIG. 11 with further alternative coupling members;

FIG. 17a A view corresponding to FIG. 12 with the further coupling members,

FIG. 17b The detail XVIIb from FIG. 17;

FIG. 17c The detail XVIIc from FIG. 17a;

FIG. 17d A plan view of the circuit board;

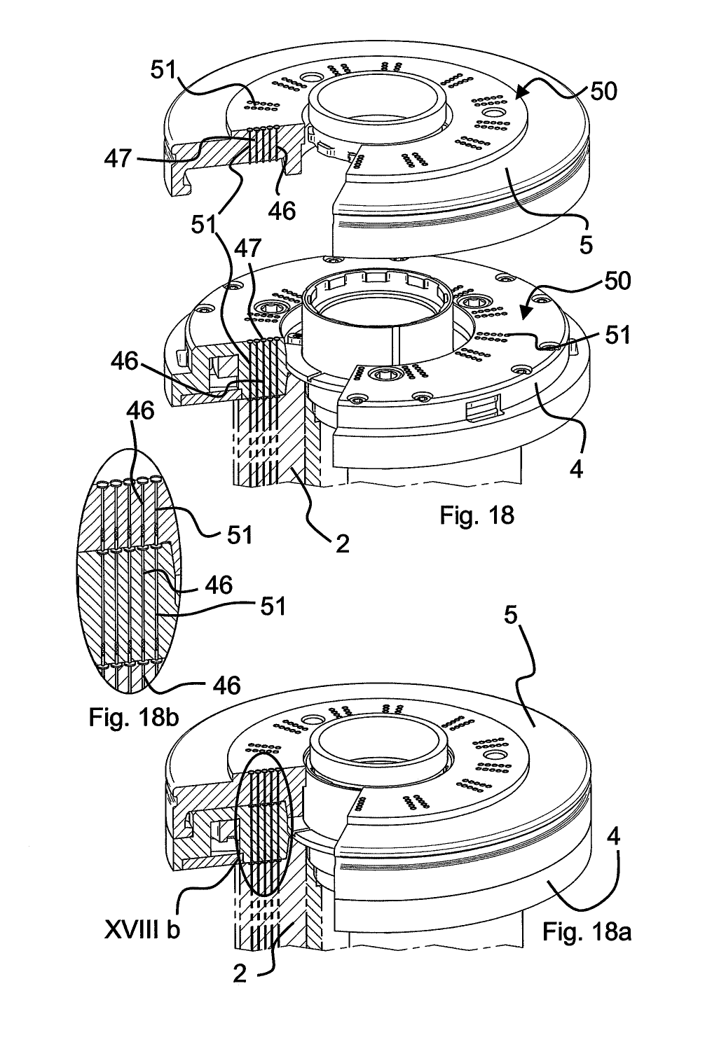

FIG. 18 A view corresponding to FIG. 11 of the further alternatives;

FIG. 18a A view corresponding to FIG. 12 of a further alternative;

FIG. 18b The detail XVIIIb from FIG. 18a;

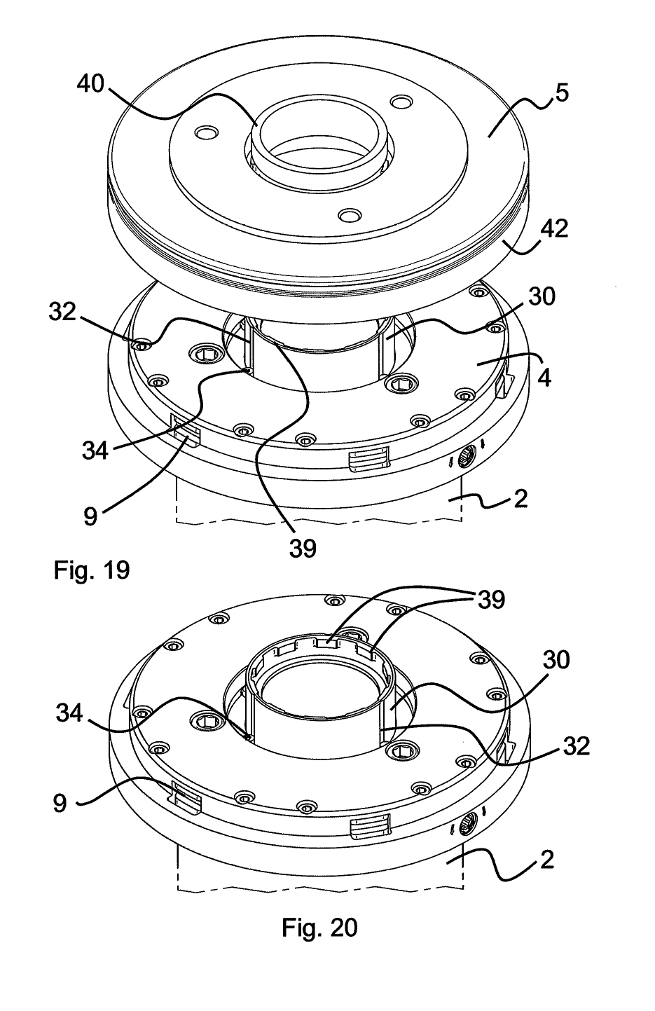

FIG. 19 A perspective view of the chucking tool, supplemented by an exchangeable flange;

FIG. 20 A view corresponding to FIG. 1a with a drawtube adapter associated with the chucking tool;

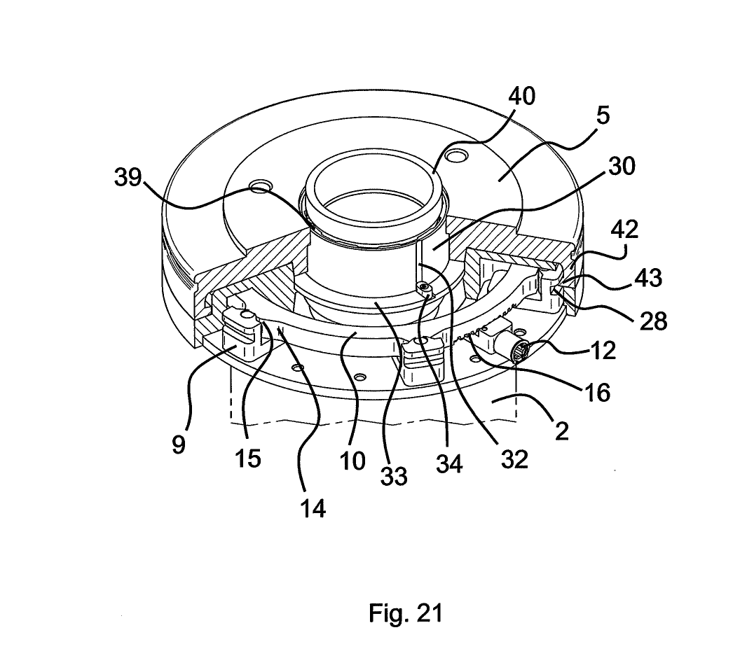

FIG. 21 A view corresponding to FIG. 19 with a sectoral cutout;

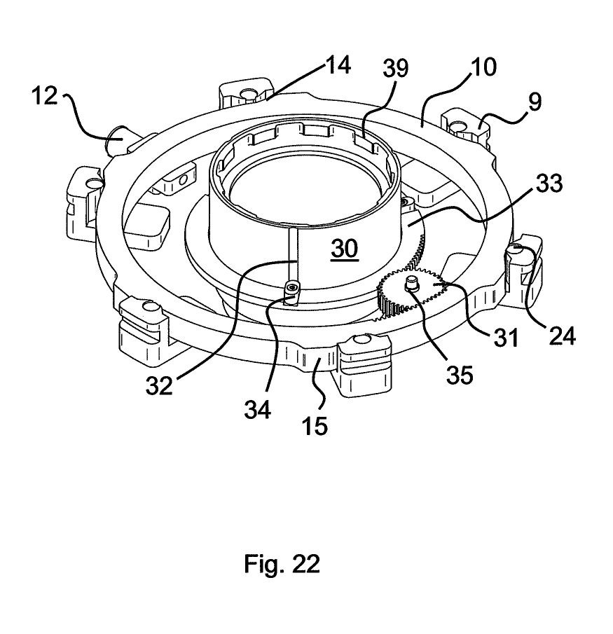

FIG. 22 An isolated view of the drive ring with the jaws and the drawtube adapter with support ring and coupling member, shown in the rotational position open position;

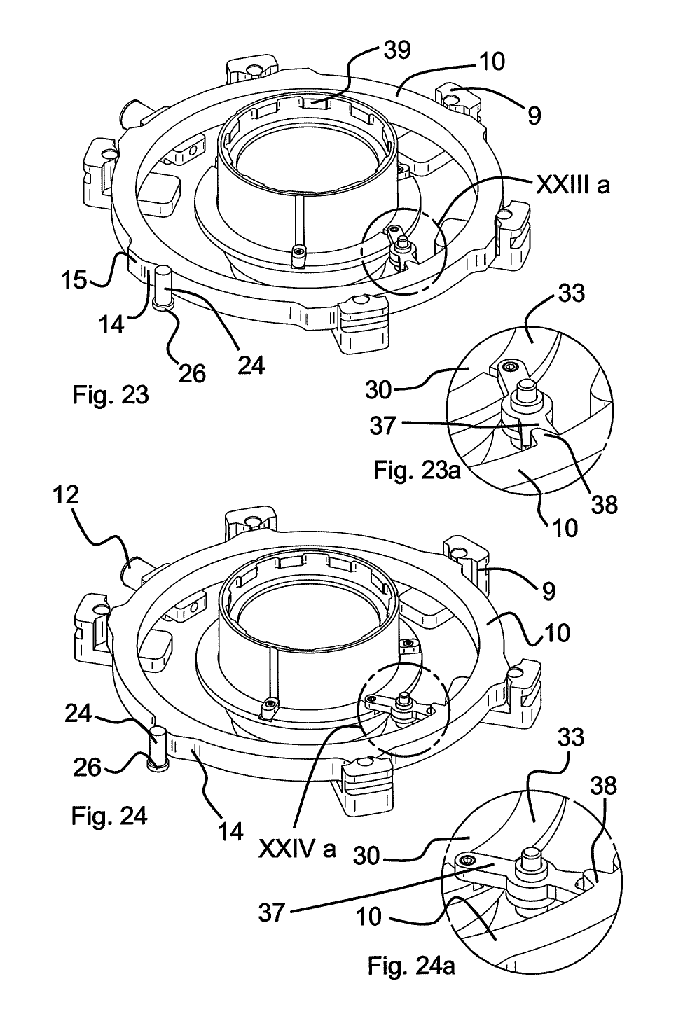

FIG. 23 A view corresponding to FIG. 22 of an additional coupling member;

FIG. 23a The detail XXIII a from FIG. 23;

FIG. 24 A view corresponding to FIG. 23 in the other clamping position;

FIG. 24a The detail XXIV a from FIG. 24;

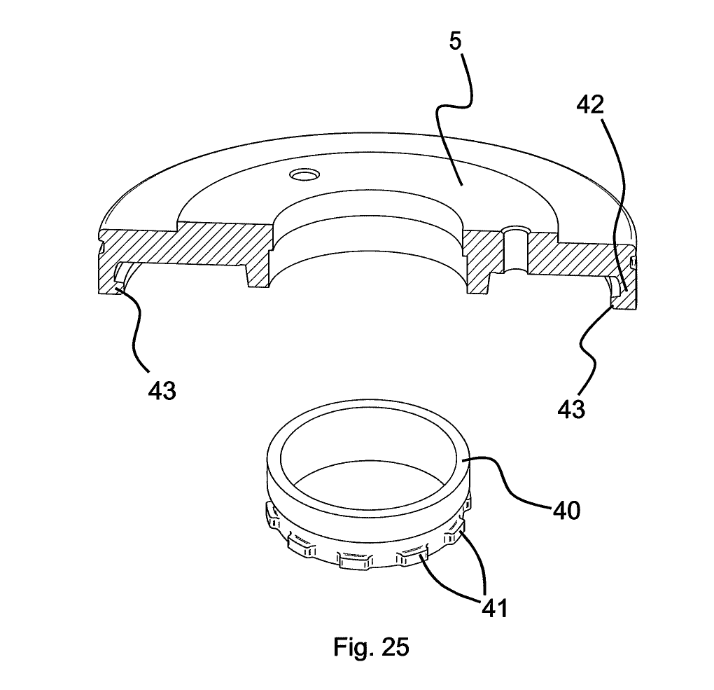

FIG. 25 An exploded view of the exchangeable flange with the coupling sleeve; the exchangeable flange is shown in section;

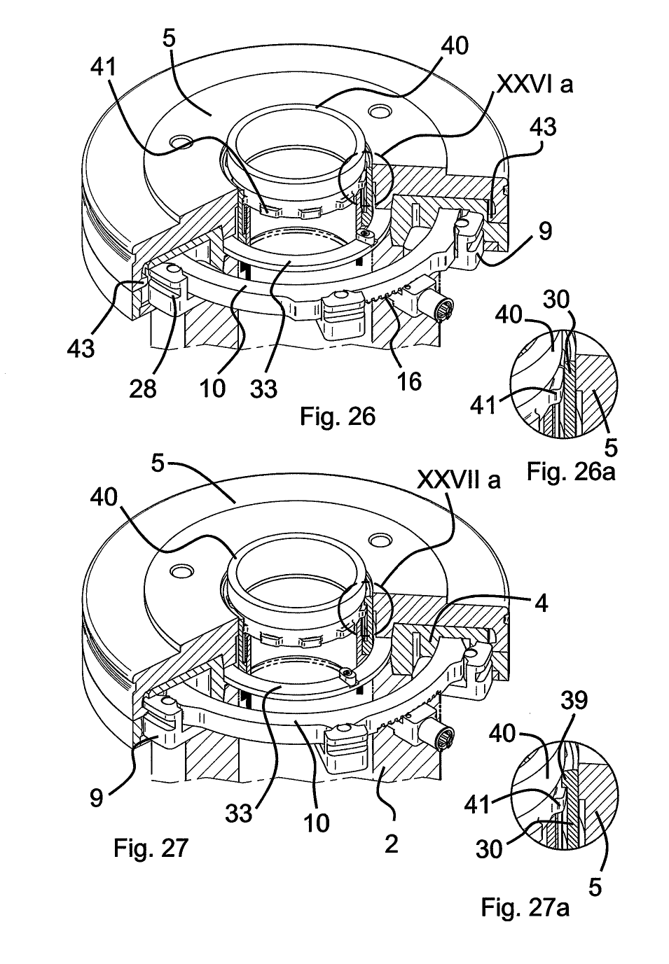

FIG. 26 A view corresponding to FIG. 21 with a sectoral cutout;

FIG. 26a The detail XXVI from FIG. 26;

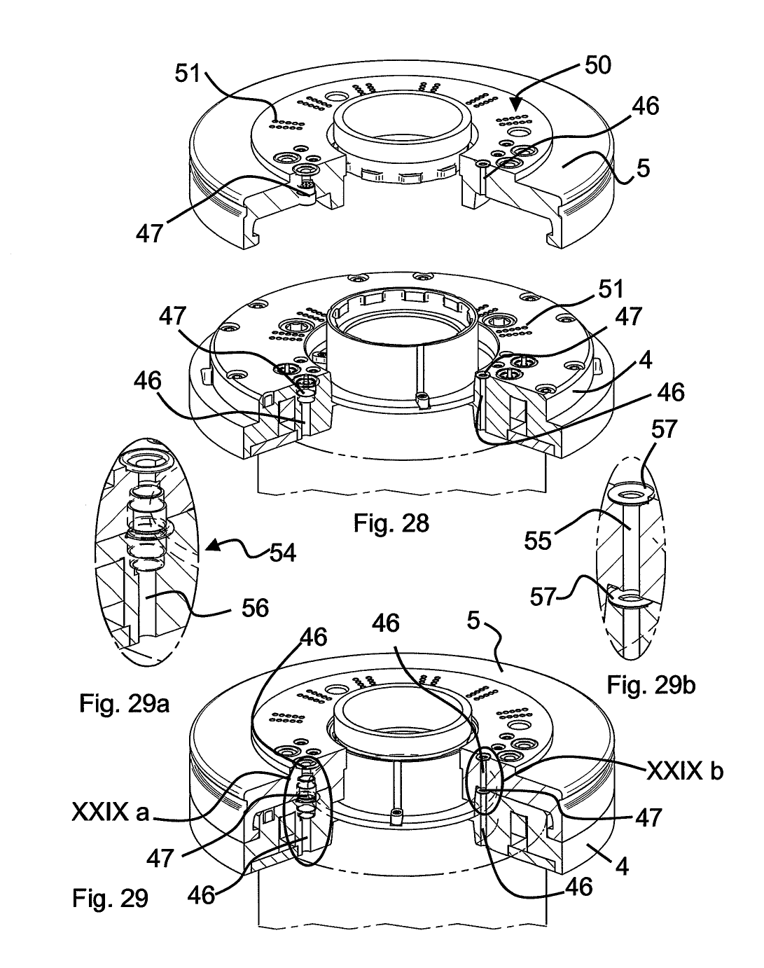

FIG. 27 The detail XXVII from FIG. 36 with the locking position corresponding to the rotational position of the drawtube adapter; and

FIG. 27a The detail XXVIIa from FIG. 27.

FIG. 1 shows a quick-change tooling system 1, which in the embodiment shown consists of a chucking tool 3 attached to the spindle 2 of a machine tool not shown further as a base flange 4 and several exchangeable flanges 5, upon which different workpiece chucking tool 6 are attached. This quick-change tooling system 1 allows for quick exchange with the chuck 6 connected to the spindle 2, whereby line sections 45, 46 are arranged in the individual components according to the invention by means of coupling members 47, in particular in order to adapt the machine control of the machine tool correctly to the new chuck 6 using the data provided by chuck 6.

The design of the chucking tool change system 1 with the integration of the energy sections 45, 46 and the coupling members 47 will be explained in the following.

FIG. 1a shows the chucking tool 3, which is provided for the attachment to the spindle 2 of a machine tool and having a chucking tool body 8 with a receptacle 7 for the spindle 2. Furthermore, the chucking tool 3 has at least two jaws 9, which are radially adjustable relative to the body axis, and a drive ring 10, for which a drive 11 is provided for its rotation in the circumferential direction. In the exemplary embodiments shown in the drawing, a total of 6 jaws 9 are provided and arranged evenly distributed over the circumference, and the drive 11 is basically formed by a drive wheel 12, which is rotatable about a radial axis.

As can be seen, in particular in FIG. 5, a structure serving to adjust each jaw 9 is formed at the outer circumference of drive ring 10, i.e., a radial cam 14 formed on the outer circumference with a radial cam 15 serving to adjust the jaws 9 radially outwardly. To complete the picture, it should be pointed out that with an adjustment of the jaws 9 provided radially inwardly, the structure may also be realized on the inner circumference of drive ring 10.

Drive teeth 16 are formed on the drive ring 10 on the side facing spindle 2, and with which the drive wheel 12 engages, thus forming a restoring cam 17 on the side of the drive ring 10 with the drive teeth 16, whereby the jaw 9 with control member 18 (FIG. 6) engages in the restoring cam.

FIGS. 7 and 8 show an embodiment, in which an indicator cam 19 is formed on the outer circumference of the drive ring 10, so as to interact with an indicator pin 20 in order to display the rotational position of the drive ring 20. The indicator pin is preferably arranged in a radial bore of the chucking tool body 8, such that its position is visually recognizable from the outside; however, the radial position of the indicator pin 20 may likewise be checked by means of a sensor for influencing the machine tool control.

FIGS. 9 to 10 show that the basic form of the jaws 9 is L-shaped, whereby the control member 18 is arranged on the base leg 21. A pin receptacle 23 open to the drive ring 10 is formed in the second leg 22, wherein a contact pin 24 having an end face 25 on the side associated with the drive ring 10 is inserted. Furthermore, the contact pin 24 has a pin base 26, which is secured via a retaining ring 27 in the pin receptacle 23. FIG. 10, in particular, shows that the jaws 9 have a groove 28 facing radially outward, whose walls 29 are formed in an inclined fashion, such that the groove 28 tapers toward the base of the groove.

Line sections 45, 46 for data and/or energy transfer are arranged in the spindle 2, the base flange 4, the exchangeable flange 5 and the chucking tool 6, whereby coupling members 47 for connecting the line sections 45, 46 to form a single line (FIG. 11) are provided on adjacent components in the transfer chain. The coupling members 47 may be designed in various alternatives as a plug-socket connection 48 (FIG. 11) or as an inductive coupler 49 (FIG. 14). It is also conceivable that one of at least two adjacent coupling members 47 is formed by a plurality of contact points 50 and the other, by corresponding resilient pins 51 (FIG. 18), or that one of at least two adjacent coupling members 47 is formed by a circuit board 52 with at least one contact loop 53, and the other, by at least one resilient pin 51 (FIG. 17).

Preferably, the contact points 50 of all adjacent components in the transfer chain are linearly and coaxially arranged relative to the spindle axis and sealed by gaskets or 0-rings relative to the environment.

The jaws of the workpiece chucking tool 6 are adjusted in a conventional manner by means of the drawtube associated with the machine tool, such that when applying the chucking tool 3 as a base flange 4, a drawtube adapter 30, which is at least limitedly rotatable, is associated with the chucking tool 3, and whose rotation by means of at least one coupling member 31 may be derived from the rotation of the drive ring 10. For this purpose, at least one axially extending adapter groove 30 is formed on the drawtube adapter 32 (FIG. 21), in which a slot nut 34 arranged on a support ring 33 engages. The coupling member 31 is provided for rotating the support ring 33, whereby the embodiment shown in FIGS. 23 and 24 shows a drive pinion 35 as a coupling member 31, which engages in external teeth formed on the support ring 33 and internal teeth formed on the drive ring 10.

The embodiment, shown in FIGS. 23 to 24, as a coupling member 31 shows a two-armed lever 37, which is mounted on an axle, and whose free lever ends are coupled to the drive ring 10 and the support ring 33. The carrier ring 33 associated with the free end of the two-armed lever 37 engages with a pin in a radially oriented groove, while the end associated with the drive ring 10 is forked and embraces a fork cam 38 of the drive ring 10.

Mutually spaced apart locking cams 39 are formed on the drawtube adapter 30 in the circumferential direction, while opposing cams 41, which are likewise spaced in the circumferential direction, are formed on a coupling sleeve 40 associated with the exchangeable flange 5. Here, the distance is dimensioned such that when an approach movement of the exchangeable flange 5 with the coupling sleeve 40 takes place in the axial direction, the locking cams 39 of the base flange 4 are able to pass between the opposing cam 41, such that when the drawtube adapter 30 is rotated, the opposing cam 40 will embrace the locking cam 39.

FIG. 25 shows that the exchangeable flange 5 has a neck 42, from which a collar 43 protrudes radially inward, whereby the walls of the groove 28 or jaws 9 and of the collar 43 coming into contact in order to produce a pull-down effect are formed in an inclined fashion.

The operating principle of the invention will be explained in the following.

Thus, as a substitute for a conventional chuck, it is possible to connect the chucking tool body 8 once to the spindle 2 of the machine tool, using the screws provided for this purpose. The chucking tool 3 thus connected to the spindle 2 is already suitable for clamping workpieces or tools, which is why it is also possible to clamp an exchangeable flange 5. To perform clamping, first the drive wheel 12 is actuated and the drive ring 10 rotated such that the jaws 9 are in the open position, i.e., the radial cam 15 will not interact with the end face 25 of contact pin 24 of the jaws 9. At the same time, the coupling member 31 ensures that the support ring 33 turns the drawtube adapter 30 into the open position via the slot nut 34. In this position, the exchangeable flange 5 with its coupling sleeve 40 may be mounted axially on the base flange 4, such that the opposing cams 41 of the coupling sleeve 40 are guided past the locking cam 39 of the drawtube adapter 30. When reaching this constellation, the drive wheel 12 is rotated such that the drive ring 10 is rotated from the open position to the clamping position, while the radial cam 15 adjusts the jaws 9 radially outward, such that these embrace the collar 43 formed on the neck 42 of the exchangeable flange 5 with the groove 28. This radial adjustment of the jaws 9 creates a pull-down effect due to the inclination of the walls of the groove 28 and the collar 43, which gives rise to a defined axial position of the exchangeable flange 5 relative to the base flange 4. In this position, a secure contact of the coupling members 47 for connecting the components adjacent to the line sections 45, 46 is present.

It should be noted that when clamping the exchangeable flange 5, rotation of the carrier ring 33 is already achieved via the coupling member 31, such that the locking cams 39 arranged staggered and axially relative to the opposing cams 41 are turned with the drawtube adapter 30, thereby causing the opposing cam 41 and locking cam 39 to overlap in the manner of a bayonet closure. Thus, the connection of the base flange 4 and the exchangeable flange 5 is completed, and the coupling sleeve 40 may be axially adjusted by operating the drawtube of the machine tool via the drawtube adapter 30, e.g., in order to adjust the jaws of a chuck 6 mounted on the exchangeable flange 5.

To release the connection of the exchangeable flange 5 and the base flange 4, only the drive wheel 12 will have to be rotated in the opposite direction, such that the drive ring 10 is rotated from the clamping position to the open position. This causes the drawtube adapter 30 to rotate, such that the locking cams 39 and the opposing cams 41 no longer overlap. Simultaneously, the jaws 9 are displaced radially inward by the control member 18 adjacent to the restoring cam 17, such that the groove 28 of the jaw 9 disengages the collar 43 of the exchangeable flange 5, with the result that the exchangeable flange 5 may be removed axially from the base flange 4. Subsequently, another exchangeable flange 5 with a chuck 6 of different characteristics may be attached to the base flange 4 and thus the machine tool, which [exchangeable flange] may be recognized individually due to the contacting of coupling members 47 thus occurring, while forming a closed line from the machine tool.

### REFERENCE NUMERAL LIST

1 Quick-change system
2 Spindle
3 Chucking tool
4 Base flange
5 Exchangeable flange
6 Workpiece chucking tool
7 Receptacle
8 Chucking tool body
9 Jaws
10 Drive ring
11 Drive
12 Drive wheel
13 Spindle drive
14 Radial cam
15 Radial cam
16 Drive teeth
17 Restoring cam
18 Control member
19 Indicator cam
20 indicator pin
21 Base leg
22 Second leg
23 Pin receptacle
24 Contact pin
25 End face
26 Pin base
27 Retaining ring
28 Groove
29 Walls
30 Long-tube adapter
31 Coupling member
32 Adapter groove
33 Support ring
34 Slot nut
35 Drive part
36 Strut
37 Lever
38 Fork cam
39 Locking cam
40 Coupling sleeve
41 Opposing cam
42 Neck
43 Collar
44 Eccentric
45 Line section
46 Line section
47 Coupling members
48 Plug-to-socket connection
49 Inductive coupler
50 Contact point
51 Pin
52 Circuit board
53 Contact loop

1. A machine tool apparatus having a spindle (2), with a base flange (2) provided for attachment to the spindle (4) as part of a quick-change tooling system (1), which further comprises an exchangeable flange (5) connectable to a chucking tool (3), configured with line sections (46, 45, 54, 55) for data and/or energy transfer are arranged in the spindle (2), a base flange (4), an exchangeable flange (5) and a workpiece chucking tool (6), and a coupling member (47) for connecting said line sections (45, 46) to form a single line are provided on adjacent components in the transfer chain.

2. A machine tool apparatus according to claim 1, wherein said base flange (2) has at least two jaws (9), which are adjustable radially relative to the spindle axis, with a radially formed groove (28), as well as a drive ring (10) provided for adjusting one or more jaws (9), whereby said exchangeable flange (5) has a neck (42) with a radially projecting collar (43), and in that the contacting walls of the groove (28) and the collar (43) are formed inclined in order to produce a pull-down effect.

3. A machine tool apparatus according to claim 1, wherein at least two adjacent coupling members (47) are designed as a plug-socket connection (48).

4. A machine tool apparatus according to claim 1, wherein at least two adjacent coupling members (47) are designed as an inductive coupler (49).

5. A machine tool apparatus according to claim 1, wherein one of at least two adjacent coupling members (47) is formed as a plurality of contact points (50) and the other as corresponding resilient pins (51).

6. A machine tool apparatus according to claim 1, wherein one of at least two adjacent coupling members (50) is formed as a circuit board with at least one contact loop (53), and the other as at least one resilient pin (51).

7. A machine tool apparatus according to claim 1, wherein the contact points (50) of all adjacent components in the transfer chain are arranged linearly and coaxially relative to the spindle axis.

8. A machine tool apparatus according to claim 1, wherein the contact points (50) are sealed by gaskets or O-rings relative to the environment.

9. An exchangeable flange for a quick-change tooling system, wherein a line section (45) extending continuously from top to bottom is provided for data and/or energy transfer, and which has terminal coupling members (47) for contacting coupling members (47) of the line sections (46) in the base flange (4) and the chucking tool (6).
